(19) United States
(12) Patent Application Publication
(10) Pub. No.: US 2019/0373485 A1
(43) Pub. Date: Dec. 5, 2019

(54) WIRELESS COMMUNICATION DEVICE, WIRELESS COMMUNICATION METHOD AND BUILDING PROVIDED WITH WIRELESS COMMUNICATION DEVICE

(71) Applicant: Panasonic Intellectual Property Management Co., Ltd., Osaka (JP)

(72) Inventors: Osamu KATO, Fukuoka (JP); Yasuhiro AOYAMA, Tokyo (JP)

(21) Appl. No.: 16/467,920

(22) PCT Filed: Dec. 6, 2017
(86) PCT No.: PCT/JP2017/043723

§ 371 Date: Jun. 7, 2019

(30) Foreign Application Priority Data
Mar. 13, 2017 (JP) 2017-047716

(51) Int. Cl. H04W 16/20; H04B 17/309; H04L 5/00; H04B 7/14; H04W 24/02; H04W 16/28

(52) U.S. Cl. CPC H04W 16/20; H04B 17/309; H04L 5/0048; H04W 92/20; H04W 24/02; H04W 16/28; H04B 7/14

(57) ABSTRACT

Base stations arranged in closed spaces perform wireless communication with another base station present in another closed space divided by shields with shields interposed therebetween. Low-loss parts at which a passage loss of radio waves of the wireless communication is low is formed at shields. Base stations obtain communication quality of a propagation channel with another wireless communication device, and form a directivity of the wireless communication such that the communication quality is equal to or greater than a predetermined value.

### TECHNICAL FIELD

The present disclosure relates to a wireless communication device and a wireless communication method which perform signal transmission through wireless communication between multiple wireless communication devices, and a building provided with the wireless communication device.

### BACKGROUND ART

In order to perform large-capacity data transmission through wireless communication, wireless communication using a high frequency band (for example, a high super high frequency (SHF) band of 6 to 30 GHz or an extremely high frequency (EHF) band of 30 to 300 GHz. The same applies later) has been examined in the next-generation communication system such as 5th generation (5G). Since a radio wave propagation loss is large in such a high frequency band, when wireless communication within a building is assumed, it is difficult to set all spaces within the building as a communication area or a wireless communication area in which communication quality is favorable in some cases. For example, it is necessary to perform a method of relaying radio waves of the wireless communication by using multiple wireless communication devices and a method of relaying the multiple communication devices through both wireless communication and wired communication in a large building in which a long transmission distance is required.

As the related art in which the multiple wireless communication devices are relayed, PTL 1 discloses a wireless communication system that connects multiple base stations to each other through wireless multi-hop relaying. According to the related art, it is possible to perform long-distance transmission through the wireless multi-hop relaying.

### CITATION LIST

### Patent Literature

PTL 1: Japanese Patent No. 5888785

### SUMMARY OF THE INVENTION

A case where multiple wireless communication devices are relayed through wireless communication having a high frequency band and signal transmission is performed in a building having multiple closed spaces divided by walls or ceilings is assumed. Since a shield passage loss of radio waves is large and a radio wave propagation loss from a closed space surrounded by the shield to another closed space is large in the high frequency band, a signal power when the radio waves pass through the shield on a propagation channel is greatly reduced, and communication quality (for example, throughput or packet error rate) is greatly degraded. Thus, there is a problem that it is difficult to form a wireless communication link on the propagation channel between the multiple wireless communication devices provided in different closed spaces without securing desired communication quality.

The present disclosure has been made in view of the aforementioned circumstances, and an object of the present disclosure is to provide a wireless communication device and a wireless communication method which are capable of realizing wireless communication having a high frequency band in which desired communication quality is secured in a building having multiple closed spaces, and a building provided with the wireless communication device.

The present disclosure is a wireless communication device arranged in a closed space. The device includes a communication unit that performs wireless communication with another wireless communication device present in another closed space divided by a shield with the shield interposed therebetween. A low-loss part at which a passage loss of radio waves of the wireless communication is low is formed at the shield, and the communication unit obtains communication quality of a propagation channel with the other wireless communication device, and forms a directivity of the wireless communication such that the communication quality is equal to or greater than a predetermined value.

The present disclosure is a wireless communication method in a wireless communication device arranged in a closed space. The wireless communication device includes a communication unit that performs wireless communication with another wireless communication device present in another closed space divided by a shield with the shield interposed therebetween, a low-loss part at which a passage loss of radio waves of the wireless communication is low is formed at the shield, and the communication unit obtains communication quality of a propagation channel with the other wireless communication device, and forms directivity of wireless communication such that the communication quality is equal to or greater than a predetermined value.

The present disclosure is a building including a plurality of closed spaces divided by shields, and a wireless communication device that performs wireless communication with another wireless communication device present in a different closed space with the shield interposed therebetween. A low-loss part at which a passage loss of radio waves of the wireless communication is low is formed at the shield, and the wireless communication device obtains communication quality of a propagation channel with the other wireless communication device, and forms a directivity of the wireless communication such that the communication quality is equal to or greater than a predetermined value.

According to the present disclosure, it is possible to realize wireless communication having a high frequency band in which desired communication quality is secured in a building having multiple closed spaces.

### BRIEF DESCRIPTION OF DRAWINGS

FIG. 1 is a diagram showing an example of a system configuration of a wireless communication system according to the present embodiment.

FIG. 2 is a diagram showing an example of a specific configuration in which the wireless communication system according to the present embodiment is arranged within a building.

FIG. 3 is a diagram showing another configuration example in which the wireless communication system according to the present embodiment is arranged within the building.

FIG. 4 is a diagram showing an example of transmission methods and reception methods using access link and backhaul link in the wireless communication system according to the present embodiment.

FIG. 5 is a schematic diagram showing an example of a directivity of beamforming transmission and beamforming reception between base stations in the wireless communication system according to the present embodiment.

FIG. 6 is a block diagram showing an example of a configuration of the base station as a core node in the wireless communication system according to the present embodiment.

FIG. 7 is a block diagram showing an example of a configuration of the base station as a slave node in the wireless communication system according to the present embodiment.

FIG. 8 is a flowchart for describing an example of an operation of multi-hop wireless communication of the backhaul link in the base station of the wireless communication system according to the present embodiment.

FIG. 9 is a diagram showing an example of a relationship between a transmission distance and throughput in wireless communication using a high frequency band.

FIG. 10 is a diagram showing a first example of an arrangement configuration of the base station.

FIG. 11 is a diagram showing a second example of the arrangement configuration of the base station.

FIG. 12 is a diagram showing a third example of the arrangement configuration of the base station.

FIG. 13 is a diagram showing a fourth example of the arrangement configuration of the base station.

### DESCRIPTION OF EMBODIMENT

Hereinafter, an embodiment (hereinafter, referred to as the “present embodiment”) in which a wireless communication device, a wireless communication method, and a building provided with the wireless communication device according to the present disclosure are specifically disclosed will be descried in detail while appropriately referring to drawings. Here, unnecessarily detailed descriptions are omitted in some cases. For example, the detailed description of the already well-known matters or the redundant description of the same configurations are omitted in some cases. Accordingly, the unnecessary redundant description is avoided in the following description, and thus, those skilled in the art can easily understand the present disclosure. The accompanying drawing and the following description are provided to allow those skilled in the art to sufficiently understand the present disclosure, and the subject matters described in the claims are not limited thereto.

(Configuration of Wireless Communication System)

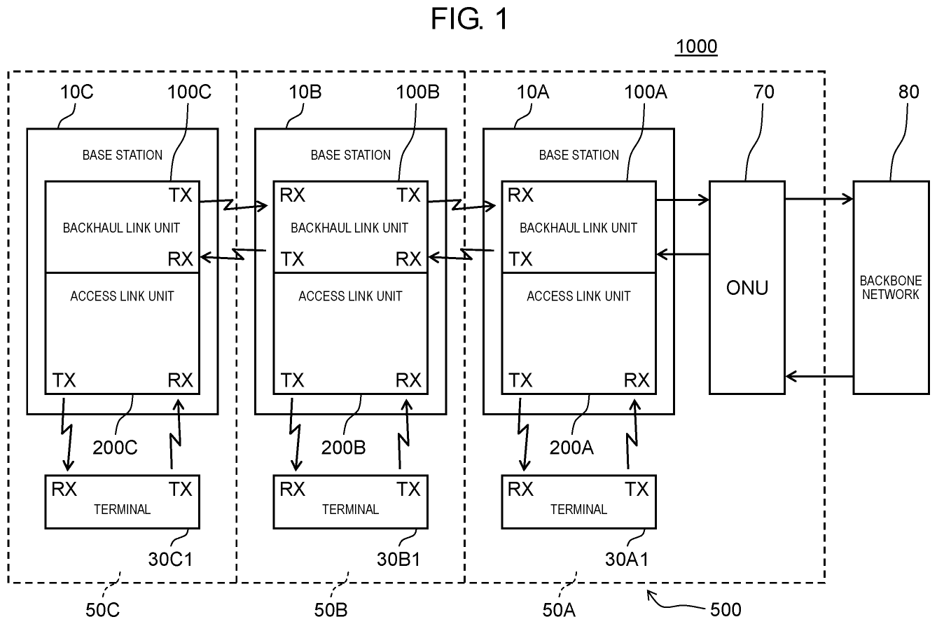

FIG. 1 is a diagram showing an example of a system configuration of a wireless communication system according to the present embodiment. In the present embodiment, a house divided into multiple rooms will be used as an example of a building having multiple closed spaces, and a configuration and an operation of the wireless communication system that performs wireless communication of a high frequency band in the building will be described. Wireless communication system 1000 includes multiple base stations (BSs) 10A, 10B, and 10C as an example of the wireless communication device, and multiple terminals (TMs) 30A1, 30B1, and 30C1.

Base stations 10A, 10B, and 10C form wireless communication links of backhaul (BH) links (that is, links between the base stations and a backbone network) between the base stations, and relay transmit data items between multiple base stations 10A, 10B, and 10C through multi-hop wireless communication. Base station 10A as a core node is connected to optical network unit (ONU) 70, and is connected to backbone network 80 through ONU 70. In the illustrated example, base station 10A close to backbone network 80 (on an upstream side of the backhaul link) is a core node of the multi-hop wireless communication, and base stations 10B and 10C close to an end (on a downstream side of the backhaul link) are slave nodes of the multi-hop wireless communication. A communication path between the core node and the backbone link is not necessarily an optical fiber link, and may be, for example, fixed wireless access (FWA) of a microwave band or a millimeter wave band. In this example, since the optical fiber link is used as the example, the ONU is directly connected to the core node.

Base station 10A is wirelessly connected to terminal 30A1, base station 10B is wirelessly connected to terminal 30B1, and base station 10C is wirelessly connected to terminal 30C1. Wireless communication links of access links (that is, links between the base stations and the terminals) are formed between base stations 10A, 10B and 10C and terminals 30A1, 30B1, and 30C1. Base stations 10A, 10B, and 10C include backhaul link units 100A, 100B, and 100C, and access link units 200A, 200B, and 200C, respectively. It is possible to perform two systems of wireless communications of communication of the backhaul links between the base stations and communication of the access links between the base station and the terminal. In the wireless communication system according to the present embodiment, it is assumed that a high frequency band (for example, a high SHF band or EHF band) is used as frequencies of the wireless communication using base stations 10A, 10B, and 10C in order to realize high-throughput data transmission.

Building 500 provided with wireless communication system 1000 is, for example, a house having multiple rooms divided by walls or ceilings, and has closed spaces 50A, 50B, and 50C as these rooms. In the illustrated example, base station 10A is arranged in closed space 50A, base station 10B is arranged in closed space 50B, and base station 10C is arranged in closed space 50C. Wireless communication using the access links between the base stations and the terminals is performed in closed spaces 50A, 50B, and 50C. The closed spaces of closed space 50A and closed space 50B perform the wireless communication using the backhaul link between base station 10A and base station 10B. The closed spaces of closed space 50B and closed space 50C perform the wireless communication using the backhaul link between base station 10B and base station 10C.

The number of hops and the number of base stations of the multi-hop wireless communication performed by using the backhaul links between multiple base stations are not limited to the illustrated example. Multiple base stations are appropriately arranged depending on the system configuration. The number of terminals which perform the wireless communication using the access link with each base station is not limited to the illustrated example. One or multiple terminals are appropriately arranged depending on the system configuration or the number of users. Building 500 is not limited to the house, and may be applied to various buildings.

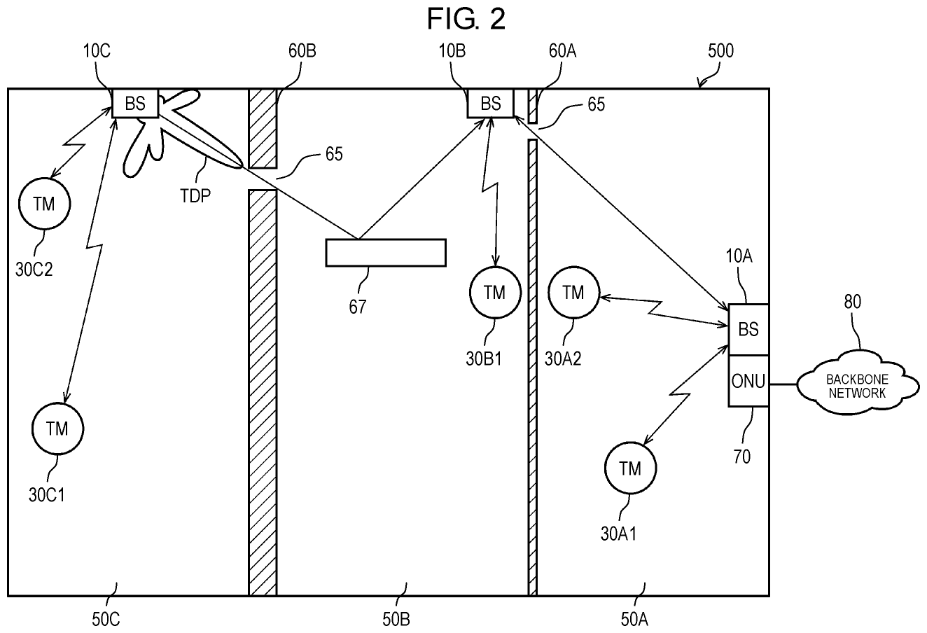

FIG. 2 is a diagram showing an example of a specific configuration in which the wireless communication system according to the present embodiment is arranged within the building. In building 500, multiple rooms are provided on one floor, and multiple closed spaces 50A, 50B, and 50C are arranged in line in each room. Shield 60A due to a wall is provided between closed space 50A and closed space 50B, and shield 60B due to a wall is provided between closed space 50B and closed space 50C.

Base station (BS) 10A and ONU 70 connected to backbone network 80 provided outside are provided in closed space 50A, and base station 10A is connected to ONU 70. Base station 10A performs the wireless communication using the access link with terminals (TMs) 30A1 and 30A2 in the space of closed space 50A (within the room). Base station (BS) 10B is provided in closed space 50B, and base station 10B performs the wireless communication using the access link with terminal (TM) 30B1 in the space of closed space 50B. Base station (BS) 10C is provided in closed space 50C, and base station 10C performs the wireless communication using the access link with terminals (TMs) 30C1 and 30C2 in the space of closed space 50C. Although it has been described in the illustrated example that one or two terminals are present in each closed space, the number of terminals is not limited thereto.

Base station 10A present in closed space 50A and base station 10B present in another closed space 50B perform the wireless communication using the backhaul link with shield 60A interposed therebetween. Base station 10B present in closed space 50B and base station 10C present in another closed space 50C perform the wireless communication using the backhaul link with shield 60B interposed therebetween. That is, the backhaul links are formed between the base stations by base station 10A connected to ONU 70 and base stations 10B and 10C arranged without the wiring of the communication links. In the present embodiment, low-loss part 65 at which a passage loss of radio waves is low is partially provided at each of shields 60A and 60B. When the multi-hop wireless communication between the base stations is performed, base stations 10A, 10B, and 10C form a directivity of transmit radio waves by using a beamforming (BF) technique, and use low-loss parts 65 of shields 60A and 60B, as paths of the radio waves.

For example, low-loss part 65 is formed by a hole formed in a wall or a floor, a tubular member, a thin recess portion, or a member made of a material having a low passage loss. When holes are formed in shields 60A and 60B, low-loss parts 65 may be through-holes. Protective materials or coating materials may be formed on outer surfaces of the holes, and thus, the holes may not be exposed. The hole of low-loss part 65 may be a space of an air layer, or may be filled with a material having a low passage loss. For example, when a communication frequency band is a 28 GHz band, since a wavelength is about 11 mm, it is possible to considerably reduce a propagation loss of a radio wave even though a diameter of low-loss part 65 is a small diameter of about 20 to 50 mm. Shields 60A and 60B may have low-loss parts 65 formed at at least a part thereof. When a shield passage loss is not large such as a case where a thickness of the wall is thin and a material of the wall has a small passage loss, the shield itself can be regarded as having the low-loss part, and the hole may not be necessarily formed in the shield.

When the wireless communication using the high frequency band is performed over the multiple closed spaces, the shield passage loss of the radio waves is large, and a radio wave propagation loss for another closed space from a closed space surrounded by the shield becomes large. For example, at the 28 GHz band, a shield passage loss is about 40 dB for an iron door, is about 30 dB for a concrete wall, and is about 20 dB for a glass window. In such a configuration having the shield, the radio waves of the transmit data items pass toward low-loss part 65, and thus, the passage loss can be reduced. Accordingly, it is possible to realize wireless communication with high communication quality (high throughput and low packet error rate).

In the example of FIG. 2, when the transmit data items are transmitted to base station 10B from base station 10C with shield 60B interposed therebetween, base station 10C forms directivity pattern TDP (transmit direction pattern) (transmit beam pattern or radiation pattern) of the transmit radio waves through the beamforming, and transmits the transmit radio waves having a sharp directivity to low-loss part 65 of shield 60B. In this case, direction pattern TDP is formed such that the maximum energy of the transmit radio waves passes through low-loss part 65 and the loss is minimized. Hereinafter, the beamforming during the transmission using the base station is referred to as “base station beamforming transmission (base station BF transmission)”. The transmit radio waves from base station 10C present in closed space 50C pass through low-loss part 65, enter closed space 50B, and are propagated to base station 10B. It is assumed that the radio waves are reflected from reflection object 67 such as a table, furniture, or a wall in the middle of a propagation channel from a transmission unit to a reception unit. In this case, elements contributing to received signal quality at the propagation channel, such as a directivity of the transmit radio waves in base station 10C, a position of low-loss part 65, the presence or absence or a position of reflection object 67, and a directivity of received sensitivity in base station 10B are set such that received signal quality in base station 10B is a favorable state of a predetermined value or more. The same base station beamforming transmission is performed for backward communication from base station 10B to base station 10C and communication between base station 10B and base station 10A.

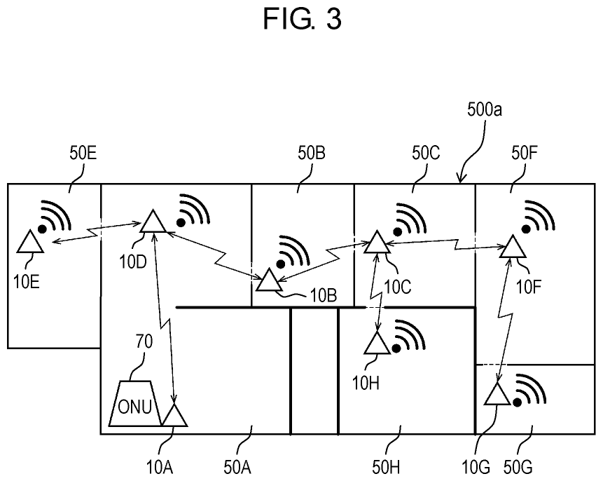

FIG. 3 is a diagram showing another configuration example in which the wireless communication system according to the present embodiment is arranged within the building. In building 500a, multiple rooms are provided on two floors, each room is divided into multiple rooms by ceilings or floors, and multiple closed spaces 50A, 50B, 50C, 50E, 50F, 50G, and 50H are arranged. Closed space 50A is an atrium style two-level space. Base stations 10A and 10D are provided in closed space 50A, base station 10B is provided in closed space 50B, base station 10C is provided in closed space 50C, base station 10E is provided in closed space 50E, base station 10F is provided in closed space 50F, base station 10G is provided in closed space 50G, and base station 10H is provided in closed space 50H. As in the example of FIG. 2, base stations 10A to 10H perform the communication using the backhaul links through the multi-hop wireless communication using the base station beamforming transmission. The directivity of the transmit radio waves is formed such that the radio waves pass through low-loss part 65 as the shield. For example, a wiring configuration of building 500a may be a configuration in which a part of the communication using the backhaul links between the base stations is wired communication such as a case where the wiring of electric light lines or communication lines between the closed spaces of the floors can be used. The number of base stations or the number of hops of the multi-hop wireless communication may be appropriately set depending on the configuration of building 500a.

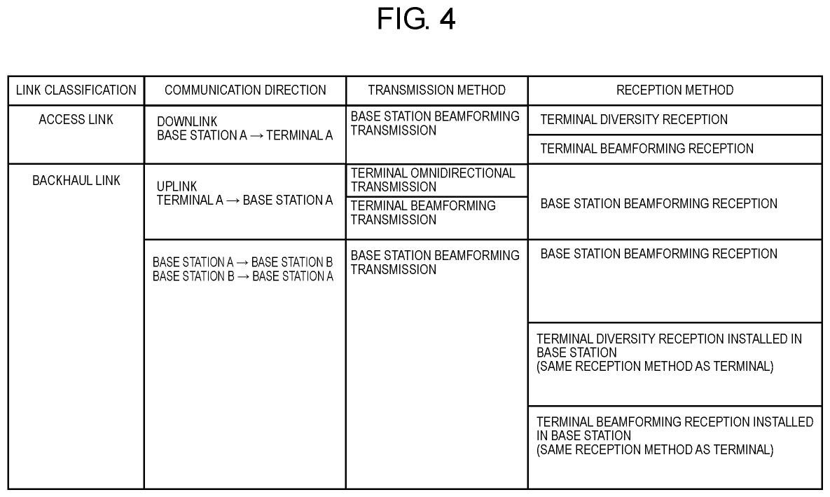

Hereinafter, the directivity of the wireless communication in the wireless communication system according to the present embodiment will be described. FIG. 4 is a diagram showing an example of transmission methods and reception methods using the access link and the backhaul link in the wireless communication system according to the present embodiment. In the illustrated example, it is assumed that a first base station is base station A, a second base station is base station B, and a first terminal communicating with base station A is terminal A. In this example, it is assumed that the access link and the backhaul link are assigned different carrier frequencies.

In the access link between base station A and terminal A, base station A performs the base station beamforming transmission as the transmission method to terminal A in a downlink direction (base station A->terminal a) from base station A to terminal A. Terminal A on a reception side performs diversity reception (terminal diversity reception) or beamforming reception (terminal beamforming reception), as the reception method from base station A. Meanwhile, in an uplink direction (terminal A->base station A) from terminal A to base station A, terminal A performs omnidirectional transmission (terminal omnidirectional transmission) or the beamforming transmission (terminal beamforming transmission), as the transmission method to base station A. Base station A on the reception side performs the beamforming reception (base station beamforming reception) as the reception method from terminal A.

In the backhaul link between base station A and base station B, the base station on a transmission side performs the base station beamforming transmission as the transmission method to the base station as a communication counterpart in both directions of a downlink direction from base station A to base station B and an uplink direction from base station B to base station A. In this example, the beamforming transmission having a sharp directivity using multiple antennas is used as at least the base station beamforming transmission using the backhaul link. The base station on the reception side performs any of the beamforming reception (base station beamforming reception), the same diversity reception (terminal diversity reception) as that in the terminal, and the same beamforming reception (terminal beamforming reception) as that in the terminal, as the reception method from the base station as the communication counterpart. That is, it is assumed that the beamforming reception having a sharp directivity using multiple antennas or the same diversity reception or beamforming reception as the reception in the terminal is used as the reception in the base station using the backhaul link.

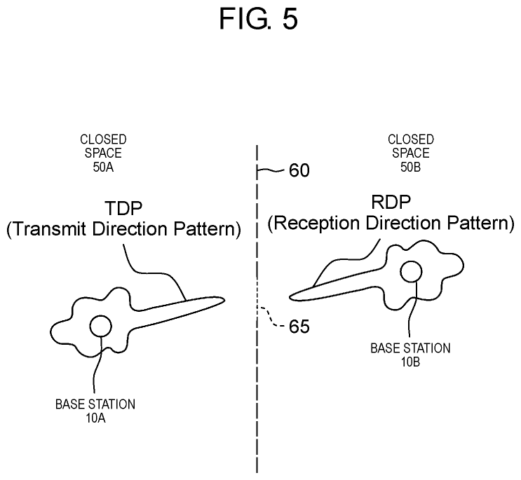

FIG. 5 is a schematic diagram showing an example of the directivity of the beamforming transmission and the beamforming reception between the base stations in the wireless communication system according to the present embodiment. The illustrated example shows an example of the beamforming communication to base station 10B present in closed space 50B from base station 10A present in closed space 50A with shield 60 interposed therebetween. Base station 10A forms direction pattern TDP (Transmit Direction Pattern) (transmit beam pattern or radiation pattern) of the transmit radio waves such that the received signal quality in base station 10B is in a favorable state of a predetermined value or more, and performs the beamforming transmission. In this case, in direction pattern TDP of the transmit radio waves, a sharp directivity with which a direction in which low-loss part 65 faces becomes a maximum transmission gain is formed. Accordingly, most of the radio waves transmitted from base station 10A pass through low-loss part 65, and are propagated to closed space 50B. Base station 10B forms direction pattern RDP (Reception Direction Pattern) (received object beam pattern) of the received sensitivity such that a received power of the radio waves transmitted from base station 10A is maximized, and performs the beamforming reception. In this case, in direction pattern RDP of the received sensitivity, a sharp directivity with which a direction in which low-loss part 65 faces becomes a maximum reception gain is formed. Accordingly, the radio waves from base station 10A which pass through low-loss part 65 are received by base station 10B with maximum sensitivity. In the high frequency band such as the high SHF band or the EHF band, since it is easy to form the directivity through the beamforming, it is possible to realize transmission and reception characteristics having a sharp directivity in a direction in which low-loss part 65 of shield 60 can be used as a part of the propagation channel.

(Configuration of Base Station)

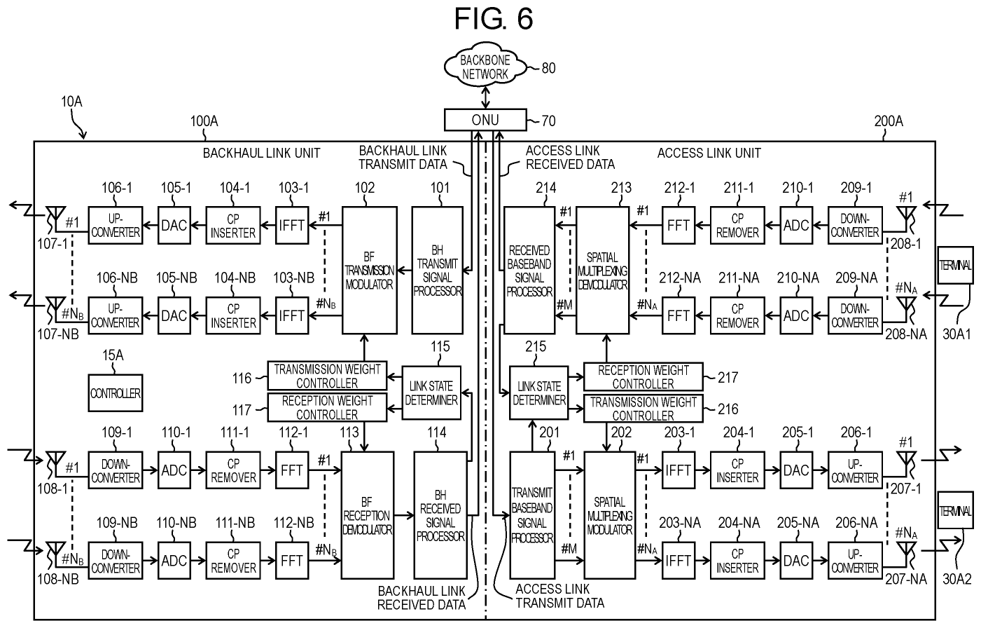

FIG. 6 is a block diagram showing an example of a configuration of the base station as the core node in the wireless communication system according to the present embodiment. Base station 10A as the core node performs the multi-hop wireless communication using the backhaul link with base station 10B as the slave node by using backhaul link unit 100A. Base station 10A performs spatial multiplexing wireless communication using the access links with multiple terminals 30A1 and 30A2 by using access link unit 200a. Base station 10A includes controller 15A which has a processor which controls operations of the host device and a memory. Controller 15A generally controls the units of backhaul link unit 100A and access link unit 200A by executing a predetermined program by using the processor. Backhaul link unit 100A and access link unit 200A are connected to backbone network 80 through ONU 70. Although it has been described in the illustrated example that each of backhaul link unit 100A and access link unit 200A is a configuration example of a wireless communication unit which performs the wireless communication using an orthogonal frequency division multiplexing (OFDM) scheme, the wireless communication scheme is not limited thereto. Any backhaul link unit may be used as long as backhaul link unit 100A performs at least the beamforming.

Backhaul link unit 100A includes backhaul transmit signal processor (BH transmit signal processor) 101 and beamforming transmission modulator (BF transmission modulator) 102. The backhaul link unit includes inverse fast Fourier transform (IFFT) units 103-1 to 103-NB, cyclic prefix (CP) inserters 104-1 to 104-NB, digital-to-analog converters (DACs) 105-1 to 105-NB, up-converters 106-1 to 106-NB, and transmit antennas 107-1 to 107-NB, as multiple systems. The number of multiple transmission systems N_{B} for the beamforming transmission is, for example, N_{B}=about 100. Backhaul link unit 100A includes receive antennas 108-1 to 108-NB, down-converters 109-1 to 109-NB, analog-to-digital converters (ADCs) 110-1 to 110-NB, CP removers 111-1 to 111-NB, and fast Fourier transform (FFT) units 112-1 to 112-NB, as multiple systems. The backhaul link unit includes beamforming reception demodulator (BF reception demodulator) 113, and backhaul received signal processor (BH received signal processor) 114. The number of multiple reception systems N_{B} for the beamforming reception is, for example, N_{B}=about 100.

Backhaul link unit 100A includes link state determiner 115, transmission weight controller 116, reception weight controller 117. As long as backhaul link unit 100A performs transmission and reception by performing time division using a time division duplex (TDD) scheme, transmit antennas 107-1 to 107-NB and receive antennas 108-1 to 108-NB can be shared for each system.

In multiple transmit antennas 107-1 to 107-NB and receive antennas 108-1 to 108-NB which perform the beamforming transmission and/or reception, when the communication frequency band is, for example, the 28 GHz band, wavelength λ is about 11 mm, and thus, antenna elements may be arranged at an interval of about 6 mm of λ/2. When N_{B}=96, the antennas are arranged in a matrix of 8×12, and an antenna array having a small size of about 48 mm×72 mm is constructed. Accordingly, it is possible to realize multiple antenna groups for the beamforming wireless communication.

As backhaul link transmit data items, the data items addressed to the terminal subordinate to the slave node other than the master node from ONU 70 are input to backhaul transmit signal processor 101. Backhaul transmit signal processor 101 performs baseband signal processing such as error correction coding, interleaving, subcarrier modulation (OFDM symbol generation) on the backhaul link transmit data items. Beamforming transmission modulator 102 generates transmit data items to which weights of the multiple systems #1 to #N_{B} are given by performing modulation for the beamforming transmission based on predetermined transmission weights input from transmission weight controller 116. IFFT units 103-1 to 103-NB convert the transmit data items of the respective systems in the frequency domain to data items in the time domain by performing IFFT, CP inserters 104-1 to 104-NB add CPs as guard intervals between data symbols to the data items, and DACs 105-1 to 105-NB convert digital signals into analog signals. Up-converters 106-1 to 106-NB perform up-conversion on baseband transmit data items to data items having a transmission frequency of a high frequency band, and transmit antennas 107-1 to 107-NB radiate transmit signals of the respective systems to which predetermined transmission weights are given, as the transmit radio waves. Accordingly, transmit antennas 107-1 to 107-NB perform the beamforming transmission such that the received signal quality in base station 10B as the slave node of the communication counterpart is the best.

Transmit radio waves from base station 10B as the slave node of the communication counterpart are received by receive antennas 108-1 to 108-NB as the multiple systems #1 to #N_{B}. Down-converters 109-1 to 109-NB perform down-conversion on received signals having a high frequency band as the received signals of the respective systems into signals having a baseband frequency, and ADCs 110-1 to 110-NB convert analog signals into digital signals. CP removers 111-1 to 111-NB remove the CPs from the received data items, and FFT units 112-1 to 112-NB convert the data items in the time domain into data items in the frequency domain by performing FFT. Beamforming reception demodulator 113 obtains OFDM symbols of the received data items by performing demodulation for the beamforming reception by giving weights to the received signals of the respective systems #1 to #N_{B} based on predetermined reception weights input from reception weight controller 117. Backhaul received signal processor 114 obtains backhaul link received data items by performing baseband signal processing such as subcarrier demodulation, deinterleaving, and error correction decoding on the received OFDM symbols. The backhaul link received data items output from backhaul received signal processor 114 are input to ONU 70.

Link state determiner 115 inputs the backhaul link received data items obtained by backhaul received signal processor 114, and determines a link state by performing the measurement of channel state information (CSI) as the link state information.

In this case, link state determiner 115 performs the CSI measurement of received data items of CSI-reference signals (RSs) transmitted from the communication counterpart. Transmission weight controller 116 obtains a CSI report from base station 10B (adjacent base station) as the communication counterpart, calculates the transmission weights based on the CSI report, and notifies beamforming transmission modulator 102 of the calculated transmission weights. Reception weight controller 117 obtains a CSI measurement result of CSI-RSs from base station 10B (adjacent base station) as the communication counterpart, calculates the reception weights based on the CSI measurement result, and notifies beamforming reception demodulator 113 of the calculated reception weights.

Access link unit 200A includes transmit baseband signal processor 201, and spatial multiplexing modulator 202. The access link unit includes IFFT units 203-1 to 203-NA, CP inserters 204-1 to 204-NA, DACs 205-1 to 205-NA, up-converts 206-1 to 206-NA, and transmit antennas 207-1 to 207-NA, as multiple systems. The number of multiple transmission systems N_{A} for spatial multiplexing transmission is, for example, N_{A}=about 100. In this example, it is assumed that spatial multiplexing communication is performed on one base station to M (for example, M=4) terminals.

Access link unit 200A includes receive antennas 208-1 to 208-NA, down-converters 209-1 to 209-NA, ADCs 210-1 to 210-NA, CP removers 211-1 to 211-NA, and FFT units 212-1 to 212-NA, as multiple systems. The access link unit includes spatial multiplexing demodulator 213, and received baseband signal processor 214. The number of multiple reception systems N_{A} for spatial multiplexing reception is, for example, N_{A}=about 100. Access link unit 200A includes link state determiner 215, transmission weight controller 216, and reception weight controller 217.

As access link transmit data items, the data items addressed to the terminals subordinate to the master node (core node) from ONU 70 are input to transmit baseband signal processor 201. Transmit baseband signal processor 201 performs baseband signal processing such as error correction coding, interleaving, and subcarrier modulation (OFDM symbol generation) on the access link transmit data items. Spatial multiplexing modulator 202 constituted by a digital precoder generates transmit data items to which weights of the multiple systems #1 to #N_{A} are given by performing modulation for spatial multiplexing transmission based on predetermined transmission weights input from transmission weight controller 216. IFFT units 203-1 to 203-NA convert the transmit data items of the respective systems in the frequency domain to data items in the time domain by performing the IFFT, CP inserters 204-1 to 204-NA add CPs as guard intervals between data symbols to the data items, and DACs 205-1 to 205-NA convert digital signals into analog signals. Up-converters 206-1 to 206-NA perform up-conversion on baseband transmit data items into data items having a transmission frequency of a high frequency band, and transmit antennas 207-1 to 207-NA radiate transmit signals of the respective systems to which predetermined transmission weights are given, as the transmit radio waves. Accordingly, transmit antennas 207-1 to 207-NA perform the spatial multiplexing transmission to M terminals 30A1 and 30A2 subordinate to the communication counterpart.

The transmit radio waves from terminals 30A1 and 30A2 as the communication counterparts are received by receive antennas 208-1 to 208-NA of the multiple systems #1 to #N_{A}. Down-converters 209-1 to 209-NA perform down-conversion on received signals having a high frequency band as the received signals of the respective systems into signals having a baseband frequency, and ADCs 210-1 to 210-NA convert analog signals into digital signals. CP removers 211-1 to 211-NA remove the CPs from the received data items, and FFT units 212-1 to 212-NA convert the data items in the time domain into data items in the frequency domain by performing the FFT. Spatial multiplexing demodulator 213 obtains OFDM symbols of the received data items by performing demodulation for the spatial multiplexing reception by giving weights to the received signals of the respective systems #1 to #N_{A} based on predetermined reception weights input from reception weight controller 217. Received baseband signal processor 214 obtains access link received data items by performing baseband signal processing such as subcarrier demodulation, deinterleaving, and error correction decoding on the received OFDM symbols. The access link received data items output from received baseband signal processor 214 are input to ONU 70.

Link state determiner 215 inputs the access link received data items obtained by received baseband signal processor 214, and determines a link state by performing the CSI measurement of the received data items of the CSI-RSs transmitted from the terminals as the communication counterparts. Transmission weight controller 216 obtains CSI reports from terminals 30A1 and 30A2 as the communication counterparts, calculates the transmission weights based on the CSI reports, and notifies spatial multiplexing modulator 202 of the calculated transmission weights. Reception weight controller 217 obtains CSI measurement results of CSI-RSs from terminals 30A1 and 30A2 as the communication counterparts, calculates the reception weights based on the CSI measurement results, and notifies spatial multiplexing demodulator 213 of the calculated reception weights.

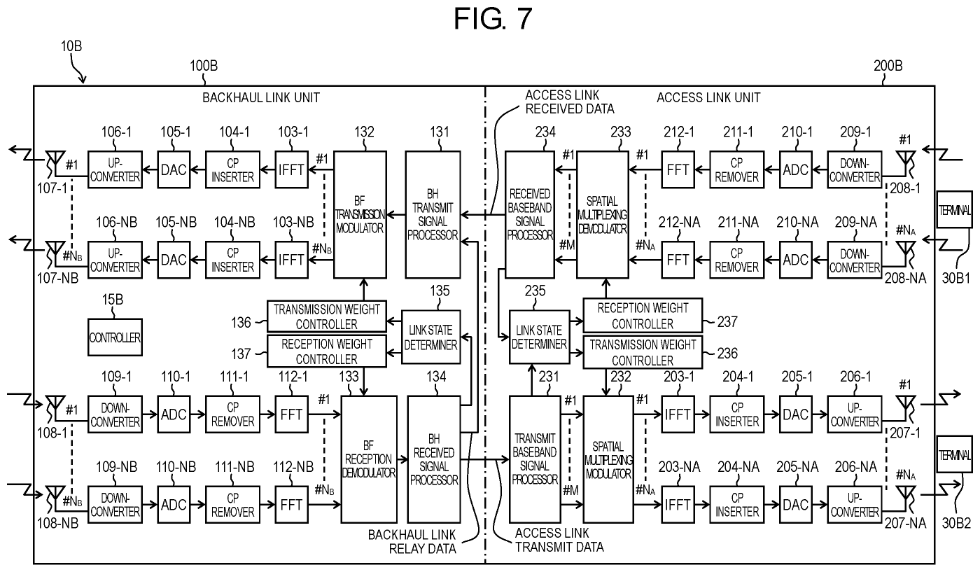

FIG. 7 is a block diagram showing an example of a configuration of the base station as the slave node in the wireless communication system according to the present embodiment. Base station 10B as the slave node performs the multi-hop wireless communication using the backhaul links with base station 10A as the core node and base station 10C as another slave node by using backhaul link unit 100B. Base station 10B performs the spatial multiplexing wireless communication using the access links with multiple terminals 30B1 and 30B2 by using access link unit 200B. Base station 10B includes controller 15B which has a processor which controls operations of the host device and a memory. Controller 15B generally controls the units of backhaul link unit 100B and access link unit 200B by executing a predetermined program by using the processor. Similarly to base station 10A as the core node shown in FIG. 6, although it has been described in the illustrated example that each of backhaul link unit 100B and access link unit 200B is a configuration example of a wireless communication unit which performs the wireless communication using the OFDM scheme, the wireless communication scheme is not limited thereto. Any backhaul link unit may be used as long as backhaul link unit 100B performs at least the beamforming.

Backhaul link unit 100B includes backhaul transmit signal processor 131, beamforming transmission modulator 132, beamforming reception demodulator 133, backhaul received signal processor 134, link state determiner 135, transmission weight controller 136, and reception weight controller 137. Since transmission units and reception units of multiple systems #1 to #N_{B} have the same configurations as those in base station 10A as the core node shown in FIG. 6, the same reference marks will be assigned, and the description thereof will be omitted.

As backhaul link relay data items, the transmit data addressed to the terminals subordinate to the node other than the master node and the received data items from the terminal subordinate to the node other than the master node are input to backhaul transmit signal processor 131 from backhaul received signal processor 134. The access link received data items from the terminals subordinated to the master node are input to backhaul transmit signal processor 131 from access link unit 200B. Backhaul transmit signal processor 131 performs baseband signal processing such as error correction coding, interleaving, and subcarrier modulation (OFDM symbol generation) on the backhaul link relay data items including the access link received data items of the master node. Beamforming transmission modulator 132 generates transmit data items to which weights of the multiple systems #1 to #N_{B} are given by performing the modulation for the beamforming transmission based on predetermined transmission weights input from transmission weight controller 136. The transmission units of the multiple systems #1 to #N_{B} radiate the transmit radio waves of the multiple systems to which the predetermined transmission weights are given, and performs the beamforming transmission such that the received signal quality in other base stations 10A and 10C as the communication counterparts is the best.

The reception units of the multiple systems #1 to #N_{B} receive the transmit radio waves from other base stations 10A and 10C as the communication counterparts, and obtain the received signals of the multiple systems. Beamforming reception demodulator 133 obtains OFDM symbols of the received data items by performing the demodulation for the beamforming reception by giving the weights to the received signals of the respective systems #1 to #N_{B} based on the predetermined reception weights input from reception weight controller 137. Backhaul received signal processor 134 obtains, as the backhaul link relay data items, the transmit data items and the received data items to and from the terminals subordinated to the node other than the master node by performing baseband signal processing such as subcarrier demodulation, deinterleaving, and error correction decoding on the received OFDM symbols. The backhaul link relay data items output from backhaul received signal processor 134 are input to backhaul transmit signal processor 131.

Link state determiner 135 inputs the backhaul link relay data items obtained by backhaul received signal processor 134, and determines a link state by performing the CSI measurement of the received data items of the CSI-RSs transmitted from the base station as the communication counterpart. Transmission weight controller 136 obtains a CSI report from the base station (adjacent base station) as the communication counterpart, calculates the transmission weights based on the CSI report, and notifies beamforming transmission modulator 132 of the calculated transmission weights. Reception weight controller 137 obtains a CSI measurement result of CSI-RSs from the base station (adjacent base station) as the communication counterpart, calculates the reception weights based on the CSI measurement result, and notifies beamforming reception demodulator 133 of the calculated reception weights.

Access link unit 200B includes transmit baseband signal processor 231, spatial multiplexing modulator 232, spatial multiplexing demodulator 233, received baseband signal processor 234, link state determiner 235, transmission weight controller 236, and reception weight controller 237. Since transmission units and reception units of multiple systems #1 to #N_{A} have the same configurations as those in base station 10A as the core node shown in FIG. 6, the same reference marks will be assigned, and the description thereof will be omitted.

As the access link transmit data items, the transmit data items addressed to the terminals subordinate to the master node are input to transmit baseband signal processor 231 from backhaul received signal processor 134. Transmit baseband signal processor 231 performs baseband signal processing such as error correction coding, interleaving, and subcarrier modulation (OFDM symbol generation) on the access link transmit data items. Spatial multiplexing modulator 232 generates transmit data items to which weights of the multiple systems #1 to #N_{A} are given by performing the modulation for the spatial multiplexing transmission based on predetermined transmission weights input from transmission weight controller 236. The transmission units of the multiple systems #1 to #N_{A} radiate the transmit radio waves of the multiple systems to which the predetermined transmission weights are given, and performs the spatial multiplexing transmission for M terminals 30B1 and 30B2 subordinate to the communication counterpart.

Meanwhile, the reception units of the multiple systems #1 to #N_{A} receive the transmit radio waves from terminals 30B1 and 30B2 subordinate to the communication counterparts as the communication counterparts, and obtain the received signals of the multiple systems. Spatial multiplexing demodulator 233 obtains OFDM symbols of the received data items by performing the demodulation for the spatial multiplexing reception by giving the weights to the received signals of the respective systems #1 to #N_{A} based on the predetermined reception weights input from reception weight controller 237. Received baseband signal processor 234 obtains access link received data items by performing baseband signal processing such as subcarrier demodulation, deinterleaving, and error correction decoding on the received OFDM symbols. The access link received data items output from received baseband signal processor 234 are input to backhaul transmit signal processor 131.

Link state determiner 235 inputs the access link received data items obtained by received baseband signal processor 234, and determines a link state by performing the CSI measurement of the received data items of the CSI-RSs transmitted from the terminals as the communication counterparts. Transmission weight controller 236 obtains CSI reports from terminals 30B1 and 30B2 as the communication counterparts, calculates the transmission weights based on the CSI reports, and notifies spatial multiplexing modulator 232 of the calculated transmission weights. Reception weight controller 237 obtains CSI measurement results of CSI-RSs from terminals 30B1 and 30B2 as the communication counterparts, calculates the reception weights based on the CSI measurement results, and notifies spatial multiplexing demodulator 233 of the calculated reception weights.

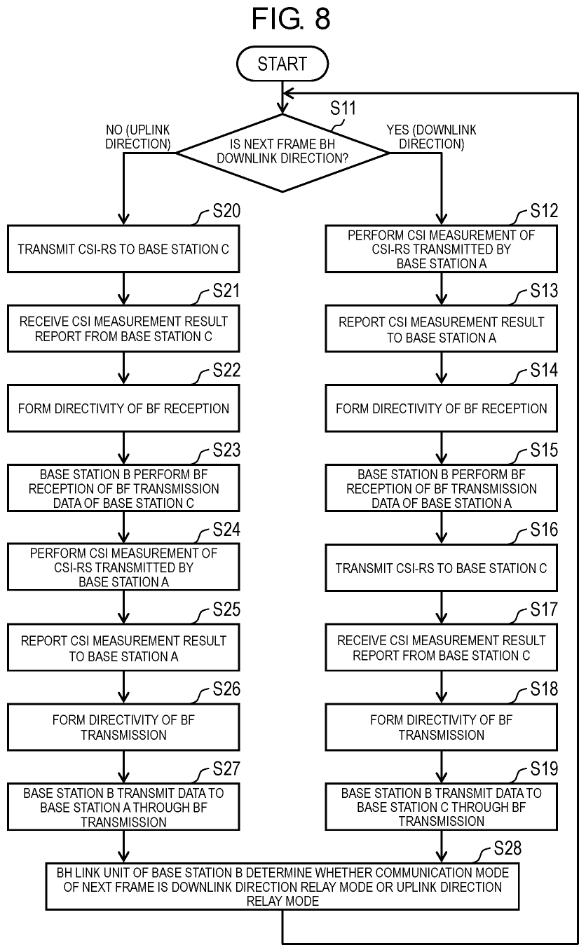

FIG. 8 is a flowchart for describing an example of an operation of the multi-hop wireless communication of the backhaul link in the base station of the wireless communication system according to the present embodiment. In the present example, the base stations are arranged toward the terminal from the core node (ONU side) in order of base stations 10A, 10B, and 10C so as to be adjacent to each other. It is assumed that communication of a direction of base station 10A->base station 10B->base station 10C is a backhaul downlink direction, and communication of a direction of base station 10C->base station 10B->base station 10A is a backhaul uplink direction. In FIG. 8, processes of backhaul link unit 100B of base station 10B that performs bidirectional relaying of the backhaul downlink direction and the backhaul uplink direction are mainly shown. Backhaul link unit 100B performs various operations under the control of controller 15B. In FIG. 8, backhaul is BH, beamforming is abbreviated to BF, base station 10A is abbreviated to base station A, base station 10B is abbreviated to base station B, and base station 10C is abbreviated to base station C.

Backhaul link unit 100B of base station 10B determines whether or not communication of the next frame is the backhaul downlink direction (S11). When the communication of the next frame is the backhaul downlink direction, that is, is the communication from base station 10A to base station 10B and the communication from base station 10B to base station 10C, backhaul link unit 100B performs the CSI measurement of the CSI-RSs transmitted from base station 10A by using link state determiner 135 (S12). Backhaul link unit 100B reports the CSI measurement result to base station 10A (S13). Backhaul link unit 100B calculates the reception weights based on the CSI measurement result by using reception weight controller 137, notifies beamforming reception demodulator 133 of the calculated reception weight, and forms the directivity of the beamforming reception (S14). Through the processes, a link state determination process between base station 10A and base station 10B such that the beamforming transmission of base station 10A and the beamforming reception of base station 10B can be performed. Backhaul link unit 100B receives the beamforming transmit data items of base station 10A (S15).

Subsequently, backhaul link unit 100B of base station 10B transmits the CSI-RSs to base station 10C (S16). Backhaul link unit 100B receives the CSI measurement result by using base station 10C (S17). Backhaul link unit 100B calculates the transmission weights based on the CSI measurement result by using transmission weight controller 136, notifies beamforming transmission modulator 132 of the calculated transmission weights, and forms the directivity of the beamforming transmission (S18). Through the processes, a link state determination process between base station 10B and base station 10C is performed such that the beamforming transmission of base station 10B and the beamforming reception of base station 10C can be performed. Backhaul link unit 100B transmits the data items to base station 10C through the beamforming transmission (S19). Accordingly, the data items of the backhaul links are relayed in the downlink direction from base station 10A to base station 10B and from base station 10B to base station 10C.

Meanwhile, when the communication of the next frame is the backhaul uplink direction, that is, is the communication from base station 10C to base station 10B and the communication from base station 10B to base station 10A, backhaul link unit 100B transmits the CSI-RSs to backhaul 10C (S20). Backhaul link unit 100B receives the CSI measurement result by using base station 10C (S21). Backhaul link unit 100B calculates the reception weights based on the CSI measurement result by using reception weight controller 137, notifies beamforming reception demodulator 133 of the calculated reception weights, and forms the directivity of the beamforming reception (S22). Through the processes, a link state determination process between base station 10C and base station 10B is performed such that the beamforming transmission of base station 10C and the beamforming reception of base station 10B can be performed. Backhaul link unit 100B receives the beamforming transmit data items of base station 10C (S23).

Backhaul link unit 100B of base station 10B performs the CSI measurement of the CSI-RSs transmitted from base station 10A by using link state determiner 135 (S24).

Backhaul link unit 100B reports the CSI measurement result to base station 10A (S25). Backhaul link unit 100B calculates the transmission weights based on the CSI measurement result by using transmission weight controller 136, notifies beamforming transmission modulator 132 of the calculated transmission weights, and forms the directivity of the beamforming transmission (S26). Through the processes, a link state determination process between base station 10B and base station 10A is performed such that the beamforming transmission of base station 10B and the beamforming reception of base station 10A can be performed. Backhaul link unit 100B transmits the data items to base station 10A through the beamforming transmission (S27). Accordingly, the data items of the backhaul links are relayed in the uplink direction from base station 10C to base station 10B and from base station 10B to base station 10A.

Backhaul link unit 100B of base station 10B determines whether a communication mode of the next frame is a downlink direction relay mode or an uplink direction relay mode (S28). In this case, backhaul link unit 100B determines the communication mode of the next frame depending on which of downlink direction relay data and uplink direction relay data is more collected. Backhaul link unit 100B returns to the process of step S11, and repeats the same processes (S11 to S28). Since base stations 10A, 10B, and 10C using backhaul links are fixedly provided in many cases, the propagation channel of the backhaul link gently fluctuates.

It is possible to significantly reduce the update frequency of the transmission weights for forming the directivity of the beamforming transmission and the reception weights for forming the directivity of the beamforming reception. For example, the transmission weights and the reception weights may not be updated for each frame, and the calculation and updating of the transmission weights and the reception weights may be performed at an appropriate timing of a loner interval (for example, one second interval).

Although it has been described in the present embodiment that the calculation of the transmission weights and the calculation of the reception weights in the beamforming transmission and reception are performed based on the measurement and report results of the CSI, other methods may be used. The calculation method is not limited as long as a propagator matrix (transfer function) between the transmit and receive antennas is obtained such that a received carrier-to-noise ratio (CNR) in the base station on the reception side is maximized and the directivity is determined. For example, it is possible to use a simple method of selecting a directivity parameter, among multiple (for example, 64) directivity parameters prepared in advance, with which the received CNR is maximized depending on a condition of performance and throughput required in the system.

(Loss Characteristics due to Shield)

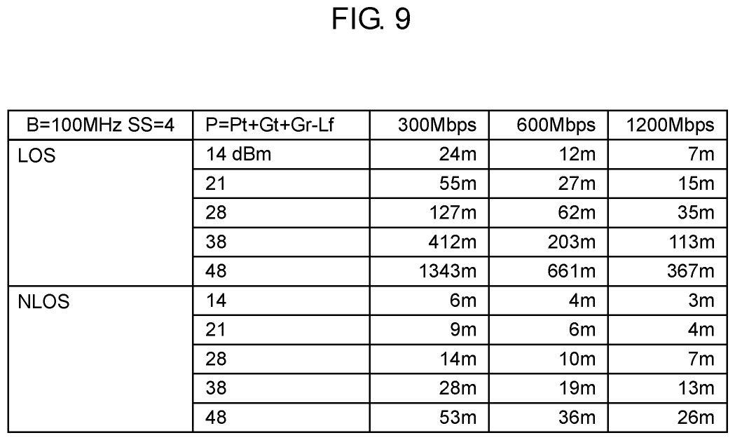

Subsequently, the propagation characteristics of the radio waves when loss incurs due to the shield in the wireless communication using the high frequency band will be described. FIG. 9 is a diagram showing an example of the relationship between a transmission distance and throughput in the wireless communication using the high frequency band.

The relationship between the transmission distance and the received CNR can be expressed by the following expression.

$$CNR = ( transmit signal power including antenna gain ) - ( radio wave propagation loss ) - ( received noise power ) = ( Pt + Gt + Gr ) - ( 20 Logf + 10 α Logd + Lf - 28 ) - ( kT + 10 LogB + Nf ) \qquad ( 1 )$$

where,

Pt: transmit power [dBm]

Gt: transmit antenna gain [dB]

Gr: receive antenna gain [dB]

f: carrier frequency [MHz]

α: radio wave propagation attenuation coefficient

d: transmission distance [m]

Lf: additional loss [dB]

k: Boltzmann constant

T: absolute temperature

B: noise bandwidth of receiver [Hz]

Nf: receiver noise figure [dB]

In Expression (1), when it is assumed that all radio wave propagation losses between the transmission and reception sides are L [dB],

L=20 Log f+10α Log d+Lf−28 (2),

when f=28000 (28 GHz), α=2.0, d=14, and Lf=0 are substituted in Expression (2), L=83.9 dB.

The example of FIG. 9 is an example in which the transmission distance and throughput are calculated by using Expression (1) when α=1.95 in a line of sight (LOS) state which is a straight line and α=3.54 in a non-line of sight (NLOS) state which is not a straight line. For example, the LOS state can be considered that the shield is not present, and the NLOS state can be considered that the shield is present. A value of the radio wave propagation attenuation coefficient α varies depending on various conditions such as indoor/outdoor. The illustrated example is an example in which the maximum transmission distances d [m] with which throughputs of 300 Mbps, 600 Mbps, and 1200 Mbps are realized are calculated for each transmit signal level when B=100 MHz and a spatial multiplexing number SS is 4.

In this case, when it is assumed that a transmit signal power P [dBm] is obtained by subtracting an additional loss Lf from a transmit signal power including antenna gain (Pt+Gt+Gr),

P=Pt+Gt+Gr−Lf (3)

Expression (3) is expressed. The passage loss in the shield is included in the additional loss Lf. In the case of P=14 dBM, when Pt=23 dBM, Gt+Gr=20 dBM, and the passage loss in the shield is considered as the additional loss Lf, Lf of 29 dB can be allowed. It is possible to increase the transmit signal power P by increasing at least one of the transmit power, the transmit antenna gain, and the receive antenna gain. In the state of NLOS, in the case of P=38 dBM, it is possible to secure a transmission distance of 19 m in a condition in which the throughput is 600 Mbps. In the case of P=48 dBM, it is possible to secure a transmission distance of 36 m in a condition in which the throughput is 600 Mbps.

(Arrangement Configuration of Base Station)

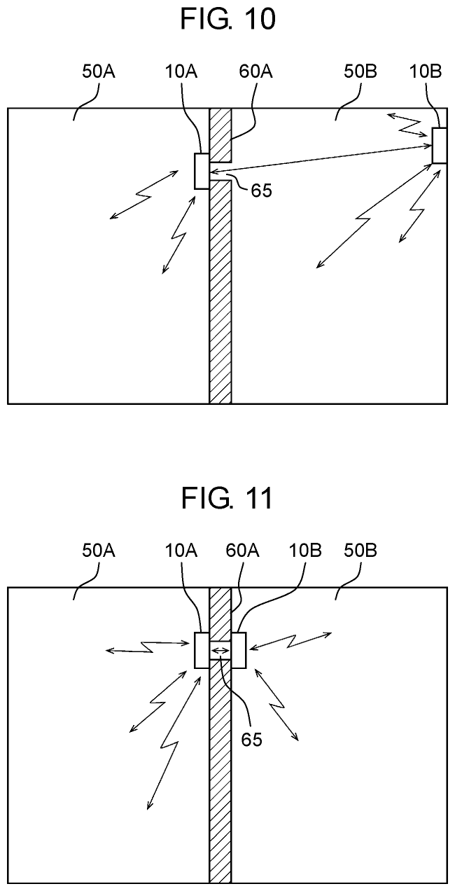

Next, several examples of an arrangement configuration of the base station in the closed space will be described. FIG. 10 is a diagram showing a first example of the arrangement configuration of the base station. The first example is an example in which base station 10A is arranged in a state in which one opening portion of low-loss part 65 is blocked in shield 60A that divides closed space 50A and closed space 50B. Base station 10A performs the wireless communication using the access link with the subordinate terminal in closed space 50A, and performs the multi-hop wireless communication using the backhaul link with another base station 10B provided in closed space 50B. Base station 10B performs the multi-hop wireless communication using the backhaul link with base station 10A, and performs the wireless communication using the access link with the subordinate terminal in closed space 50B. In the present example, since the opening portion of low-loss part 65 of shield 60A is covered by base station 10A, it is possible to avoid the damage of the appearance of the building caused by forming low-loss part 65 due to a hole. Since base station 10A is close to low-loss part 65 of shield 60A, it is possible to minimize the passage loss in shield 60A by causing the radio waves to most recently pass low-loss part 65 during the beamforming transmission using base station 10A, and it is possible to increase the power of the transmit radio waves heading for closed space 50B.

FIG. 11 is a diagram showing a second example of the arrangement configuration of the base station. The second example is an example in which base station 10A is arranged in a state in which one opening portion of low-loss part 65 is blocked and base station 10B is arranged in a state in which the other opening portion is blocked in shield 60A that divides closed space 50A and closed space 50B. Base station 10A and base station 10B are arranged on both surfaces of shield 60A with low-loss part 65 interposed therebetween such that rear surfaces are opposite to each other. Base station 10A and base station 10B perform the multi-hop wireless communication using the backhaul links with the base station by performing the beamforming transmission and reception at low-loss part 65 using an air layer or a low-loss material. In the present example, since the both surfaces of the opening portion of low-loss part 65 of shield 60A are covered by base station 10A and base station 10B, it is possible to avoid the damage of the appearance of the building caused by forming low-loss part 65 due to a hole in both closed space 50A and closed space 50B.

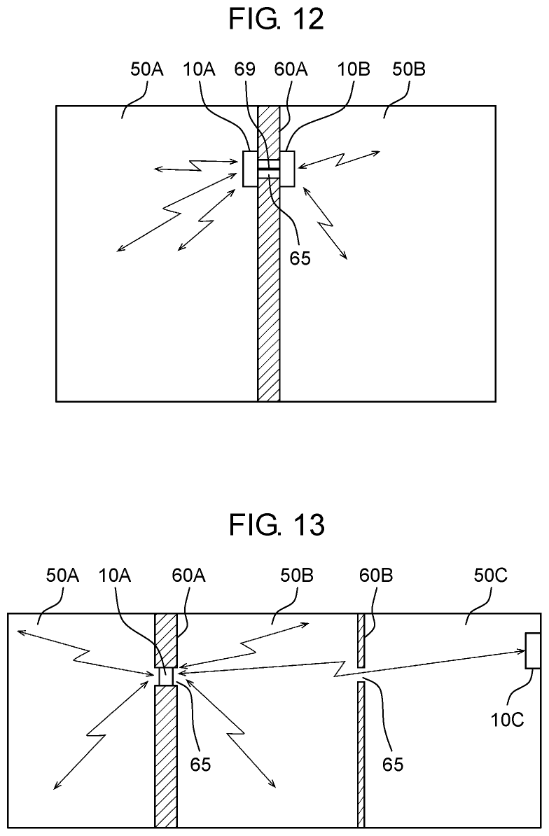

FIG. 12 is a diagram showing a third example of the arrangement configuration of the base station. Third example is a modification example of the second example, and is an example in which base station 10A and base station 10B are arranged in a state in which both surfaces of the opening portion of low-loss part 65 are blocked at shield 60A that divides closed space 50A and closed space 50B and the base stations are connected by wired communication line 69. A coaxial wire, a twisted pair wire, or a power line is used as communication wire 69. Base station 10A and base station 10B perform the communication using the backhaul link with the base station through wired communication using communication line 69. Similarly to the second example, in the present example, it is possible to avoid the damage of the appearance of the building caused by forming low-loss part 65 due to a hole. The communication using the backhaul links between multiple closed spaces can be similarly realized by partially using a wired link.

FIG. 13 is a diagram showing a fourth example of the arrangement configuration of the base station. The fourth example is an example in which base station 10A is arranged in low-loss part 65 at shield 60A that divides closed space 50A and closed space 50B. Base station 10A is arranged at a boundary portion between closed space 50A and closed space 50 across both the spaces. The base station blocks the opening portion of low-loss part 65 of shield 60A, radiates the transmits radio waves by causing the transmit radio waves to pass through low-loss part 65, and performs the wireless communication using the access link with the subordinate terminals of both closed space 50A and closed space 50B. Shield 60B that divides closed space 50B and closed space 50C is provided, and base station 10C is arranged in closed space 50C. Base station 10A performs the multi-hop wireless communication using the backhaul link with another base station 10C with low-loss part 65 of shield 60B interposed therebetween. In the present example, since base station 10A is arranged in low-loss part 65 of shield 60A and the opening portion of low-loss part 65 is blocked, it is possible to avoid the damage of the appearance of the building caused by forming low-loss part 65 due to the hole as in the first example.

Base stations 10A, 10B, and 10C may be provided integrally with a housing of equipment such as a television monitor, lighting equipment, or a speaker, and may be provided at the opening portion of low-loss part 65 formed on a wall surface or a ceiling.

As stated above, in the present embodiment, in the building which has the multiple closed spaces and is provided with the wireless communication devices arranged in the closed spaces, the low-loss part having the low passage loss is formed at the shield that divides the closed spaces. When the wireless communication device within the closed space performs the wireless communication with another wireless communication device present in another closed space, the directivity of the wireless communication is formed such that the communication quality using the low-loss part of the shield is equal to or greater than the predetermined value. According to the present embodiment, it is possible to minimize the passage loss due to the shield in the high frequency band and it is possible to realize wireless communication having high throughput in which desired communication quality and transmission distance are secured within the building.

As stated above, base stations 10A, 10B, and 10C as the examples of the wireless communication devices according to the present embodiment are arranged in closed spaces 50A, 50B, and 50C, and includes backhaul link units 100A, 100B, and 100C as the examples of the communication units that perform the wireless communication with another base station present in another closed space divided by shields 60A and 60B with shields 60A and 60B interposed therebetween. Low-loss parts 65 at which the passage loss of the radio waves of the wireless communication is low are formed at shields 60A and 60B. Backhaul link units 100A, 100B, and 100C obtain the communication quality of the propagation channel with another base station, and forms the directivity of the wireless communication such that the communication quality is equal to or greater than the predetermined value.

Accordingly, it is possible to reduce the passage loss due to shields 60A and 60B, and it is possible to realize the wireless communication in which desired communication quality between multiple closed spaces 50A, 50B, and 50C is secured. Thus, for example, it is possible to perform wireless high-speed indoor communication by forming the backhaul link having high throughput within the building.

In base stations 10A, 10B, and 10C, backhaul link units 100A, 100B, and 100C determine the transmission weights at the time of performing the transmission to another base station such that the obtained communication quality is equal to or greater than the predetermined value, and form the directivity of the wireless transmission. Accordingly, it is possible to reduce the passage loss due to shields 60A and 60B in the wireless transmission between multiple closed spaces 50A, 50B, and 50C.

In base stations 10A, 10B, and 10C, backhaul link units 100A, 100B, and 100C transmit the reference signals to another base station, obtain, as the communication quality, the link state information in another base station on the reception side, and determines the transmission weights at the time of performing the transmission to another base station such that the link state information is equal to or greater than the predetermined value. Accordingly, it is possible to reduce the passage loss due to shields 60A and 60B in the wireless communication between multiple closed spaces 50A, 50B, and 50C.

In base stations 10A, 10B, and 10C, backhaul link units 100A, 100B, and 100C receive the reference signals transmitted from another base station, obtain, as the communication quality, the link state information in the host device on the transmission side, report the link state information to another base station, and determine the transmission weights at the time of performing the transmission to another base station such that the link state information is equal to or greater than the predetermined value. Accordingly, it is possible to reduce the passage loss due to shields 60A and 60B in the wireless communication between multiple closed spaces 50A, 50B, and 50C.

In base stations 10A, 10B, and 10C, backhaul link units 100A, 100B, and 100C determine the reception weights at the time of performing reception from another base station such that the obtained communication quality is equal to or greater than the predetermined value, and form the directivity of the wireless reception. Accordingly, it is possible to reduce the passage loss due to shields 60A and 60B in the wireless reception between multiple closed spaces 50A, 50B, and 50C.

In base stations 10A, 10B, and 10C, backhaul link units 100A, 100B, and 100C receive the reference signals transmitted from another base station, obtain, as the communication quality, the link state information in the host device on the reception side, report the link state information to another base station, and determine the reception weights at the time of performing the reception from another base station such that the link state information is equal to or greater than the predetermined value. Accordingly, it is possible to reduce the passage loss due to shields 60A and 60B in the wireless reception between multiple closed spaces 50A, 50B, and 50C.

In base stations 10A, 10B, and 10C, backhaul link units 100A, 100B, and 100C transmit the reference signals to another base station, obtain, as the communication quality, the link state information in another base station on the transmission side, and determine the reception weights at the time of performing the reception from another base station such that the link state information is equal to or greater than the predetermined value. Accordingly, it is possible to reduce the passage loss due to shields 60A and 60B in the wireless reception between multiple closed spaces 50A, 50B, and 50C.

In base stations 10A, 10B, and 10C, backhaul link units 100A, 100B, and 100C form the directivity of the wireless communication in the direction in which the radio waves of the wireless communication with another base station pass through low-loss parts 65 of shields 60A and 60B. Accordingly, it is possible to increase the energy of the radio waves passing through the low-loss parts 65 and it is possible to reduce the passage loss due to shields 60A and 60B in the wireless communication between multiple closed spaces 50A, 50B, and 50C.

Building 500 according to the present embodiment includes multiple closed spaces 50A, 50B, and 50C divided by shields 60A and 60B. Closed spaces 50A, 50B, and 50C include base stations 10A, 10B, and 10C as the examples of the wireless communication devices that perform the wireless communication with another wireless communication device present in another closed space with shields 60A and 60B interposed therebetween. Low-loss parts 65 at which the passage loss of the radio waves of the wireless communication is low are formed at shields 60A and 60B. Base stations 10A, 10B, and 10C obtain the communication quality of the propagation channel with another base station, and form the directivity of the wireless communication such that the communication quality is equal to or greater than the predetermined value.

Accordingly, it is possible to reduce the passage loss due to shields 60A and 60B within building 500, and it is possible to realize the wireless communication in which desired communication quality between multiple closed spaces 50A, 50B, and 50C is secured.

In building 500, base station 10A is arranged in a state in which the opening portion of low-loss part 65 of shield 60A is blocked. Accordingly, it is possible to avoid the damage of the appearance of building 500 caused by forming low-loss part 65.

In building 500, base station 10A is arranged in the opening portion of low-loss part 65 formed on one surface of shield 60A which faces closed space 50A in which the host device is positioned. Accordingly, it is possible to avoid the damage of the appearance of building 500 caused by forming low-loss part 65. Since base station 10A is closed to low-loss part 65 of shield 60A, it is possible to minimize the passage loss in shield 60A by causing the radio waves to most recently pass low-loss part 65 during the beamforming transmission using base station 10A.

In Building 500, base stations 10A and 10B are arranged in the opening portion of low-loss part 65 formed in both surfaces of shield 60A which faces closed spaces 50A and 50B in which these base stations are positioned. Accordingly, it is possible to avoid the damage of the appearance of building 500 caused by forming low-loss part 65 in both closed space 50A and closed space 50B.

Although various embodiments have been described with reference to the drawings, the present disclosure is not limited to these examples. It should be appreciated by those skilled in the art that various change examples or modification examples are possible within the scope described in the claims, and it should be understood that these examples are included in the technical scope of the present disclosure. The components in the aforementioned embodiment may be optionally combined without departing from the gist of the invention.

### INDUSTRIAL APPLICABILITY

The present disclosure is useful as a wireless communication device and a wireless communication method which realize wireless communication having a high frequency band in which desired communication quality is secured in a building having multiple closed spaces, and a building provided with the wireless communication device.

### REFERENCE MARKS IN THE DRAWINGS

10A, 10B, 10C, 10D, 10E, 10F, 10G, 10H: BASE STATION
30A1, 30A2, 30B1, 30B2: TERMINAL
50A, 50B, 50C, 50E, 50F, 50G, 50H: CLOSED SPACE
60, 60A, 60B: SHIELD
65: LOW-LOSS PART
67: REFLECTION OBJECT
70: ONU
80: BACKBONE NETWORK
100A, 100B, 100C: BACKHAUL LINK UNIT
101, 131: BACKHAUL TRANSMIT SIGNAL PROCESSOR
102, 132: BEAMFORMING TRANSMISSION MODULATOR
113, 133: BEAMFORMING RECEPTION DEMODULATOR
114, 134: BACKHAUL RECEIVED SIGNAL PROCESSOR
115, 135, 215, 235: LINK STATE DETERMINER
116, 136, 216, 236: TRANSMISSION WEIGHT CONTROLLER
117, 137, 217, 237: RECEPTION WEIGHT CONTROLLER
200A, 200B, 200C: ACCESS LINK UNIT
201, 231: TRANSMIT BASEBAND SIGNAL PROCESSOR
202, 232: SPATIAL MULTIPLEXING MODULATOR
213, 233: SPATIAL MULTIPLEXING DEMODULATOR
214, 234: RECEIVED BASEBAND SIGNAL PROCESSOR
500: BUILDING
1000: WIRELESS COMMUNICATION SYSTEM

1. A wireless communication device arranged in a closed space, the device comprising:
a communication unit that performs wireless communication with another wireless communication device present in another closed space divided by a shield with the shield interposed therebetween,
wherein a low-loss part at which a passage loss of radio waves of the wireless communication is low is formed at the shield, and
the communication unit obtains communication quality of a propagation channel with the other wireless communication device, and forms a directivity of the wireless communication such that the communication quality is equal to or greater than a predetermined value.

2. The wireless communication device of claim 1, wherein the communication unit determines a transmission weight at the time of performing transmission to the other wireless communication device such that the communication quality is equal to or greater than the predetermined value, and forms the directivity of the wireless transmission.

3. The wireless communication device of claim 2, wherein the communication unit transmits a reference signal to the other wireless communication device, obtains, as the communication quality, link state information in the other wireless communication device, and determines the transmission weight at the time of performing the transmission to the other wireless communication device such that the link state information is equal to or greater than a predetermined value.

4. The wireless communication device of claim 2, wherein the communication unit receives a reference signal transmitted from the other wireless communication device, obtains, as the communication quality, link state information in a host device, reports the link state information to the other wireless communication device, and determines the transmission weight at the time of performing the transmission to the other wireless communication device such that the link state information is equal to or greater than the predetermined value.

5. The wireless communication device of claim 1, wherein the communication unit determines a reception weight at the time of performing reception from the other wireless communication device such that the communication quality is equal to or greater than the predetermined value, and forms the directivity of the wireless reception.

6. The wireless communication device of claim 5, wherein the communication unit receives a reference signal transmitted from the other wireless communication device, obtains, as the communication quality, link state information in a host device, reports the link state information to the other wireless communication device, and determines the reception weight at the time of performing the reception from the other wireless communication device such that the link state information is equal to or greater than the predetermined value.

7. The wireless communication device of claim 5, wherein the communication unit transmits a reference signal to the other wireless communication device, obtains, as the communication quality, link state information in the other wireless communication device, and determines the reception weight at the time of performing the reception from the other wireless communication device such that the link state information is equal to or greater than the predetermined value.

8. The wireless communication device of claim 1, wherein the communication unit forms the directivity of the wireless communication in a direction in which the radio waves of the wireless communication with the other wireless communication device pass through the low-loss part of the shield.

9. A wireless communication method in a wireless communication device arranged in a closed space,
wherein the wireless communication device includes a communication unit that performs wireless communication with another wireless communication device present in another closed space divided by a shield with the shield interposed therebetween,
a low-loss part at which a passage loss of radio waves of the wireless communication is low is formed at the shield, and
the communication unit obtains communication quality of a propagation channel with the other wireless communication device, and forms directivity of wireless communication such that the communication quality is equal to or greater than a predetermined value.

10. A building comprising:
a plurality of closed spaces divided by shields; and
a wireless communication device that performs wireless communication with another wireless communication device present in a different closed space with the shield interposed therebetween,
wherein a low-loss part at which a passage loss of radio waves of the wireless communication is low is formed at the shield, and
the wireless communication device obtains communication quality of a propagation channel with the other wireless communication device, and forms a directivity of the wireless communication such that the communication quality is equal to or greater than a predetermined value.

11. The building of claim 10, wherein the wireless communication device is arranged in a state in which an opening portion of the low-loss part of the shield is blocked.

12. The building of claim 11, wherein the wireless communication device is arranged in the opening portion of the low-loss part formed on one surface of the shield, which faces a closed space in which a host device is positioned.

13. The building of claim 11, wherein the wireless communication device and the other wireless communication device are arranged at the opening portion of the low-loss part formed on both surfaces of the shield which face the closed spaces in which the wireless communication devices are positioned.
